(19) United States
(12) Patent Application Publication
(10) Pub. No.: US 2021/0282903 A1
(43) Pub. Date: Sep. 16, 2021

(54) ZYGOMATIC DENTAL IMPLANT, GUIDE FOR ZYGOMATIC DENTAL IMPLANT, AND SURGICAL INSTRUMENTS AND SURGICAL METHOD FOR SAME

(71) Applicant: David Fischer, Springfield, IL (US)

(72) Inventor: David Fischer, Springfield, IL (US)

(21) Appl. No.: 17/105,733

(22) Filed: Nov. 27, 2020

Related U.S. Application Data
(60) Provisional application No. 62/940,759, filed on Nov. 26, 2019.

(51) Int. Cl. A61C 8/00

(52) U.S. Cl. CPC A61C 8/0034; A61C 8/0089

(57) ABSTRACT

A zygomatic dental implant guide includes a guide body a guide body configured to be secured to a maxillary of a subject, and a guide sleeve coupled to the guide body and configured to receive a zygomatic implant and guide the zygomatic implant toward a zygoma of the subject.

### CROSS-REFERENCE TO RELATED APPLICATION

The present application claims the benefit of U.S. Provisional Application No. 62/940,759, filed Nov. 26, 2019, the entirety of which is hereby incorporated by reference.

### FIELD OF THE DISCLOSURE

The present disclosure generally relates to a zygomatic dental implant, a guide for a zygomatic dental implant, surgical instruments, and a surgical method using the same.

### BACKGROUND OF THE DISCLOSURE

A zygomatic dental implant is utilized to assist in the prosthetic reconstruction of severely atrophic maxillary arches. Historically, zygomatic implants have been placed via a free hand or minimally guided technique. Previous zygomatic designs have included an external hex attachment at the restorative head. There has not been a fully guided protocol developed to assist in the accurate preparation and insertion of a zygomatic dental implant.

### BRIEF DESCRIPTION OF THE DRAWINGS

FIG. 1 is a side elevational view of a one embodiment of a zygomatic dental implant.

FIG. 2 is a side elevational view of one embodiment of a zygomatic dental implant guide.

FIG. 3 is a side elevational view of a primary guide component of the zygomatic dental implant guide.

FIG. 4 is a front elevational view of a secondary guide component of the zygomatic dental implant guide.

FIG. 5 is a side elevational view of the secondary guide component.

FIG. 6 is a coronal view of the zygomatic dental implant guide positioned on the lateral maxilla.

FIG. 7 is a side elevational view of one embodiment of a surgical drill bit.

FIG. 8 is a side elevational view of one embodiment of a drill guide instrument.

FIG. 9 is a side elevational view of one embodiment of a stabilization pin.

FIG. 10 is a side elevational view of one embodiment of a stabilization pin sleeve.

FIG. 11 is a side elevational view of one embodiment of a stabilization pin drill bit.

FIG. 12 is a side elevational view of one embodiment of a tap drill.

FIG. 13 is a front elevational view of a primary guide component of a second embodiment of the implant guide.

FIG. 14 is a front elevational view of a sinus-preparation component of the implant guide.

FIG. 15 is a front elevational view of an implant guide component of the implant guide.

FIG. 16 is a coronal view of the primary guide component and the sinus-preparation component coupled to one another and positioned on the maxilla.

FIG. 17 is a coronal view of the primary guide component and the implant guide component coupled to one another and positioned on the maxilla.

FIG. 18 is a front elevational view of an implant mount.

FIG. 19 is a top plan view of the implant mount.

FIG. 20 is a bottom plan view of the implant mount.

FIG. 21 is a front elevational view of a driver for the implant mount.

FIG. 22 is a bottom plan view of the driver.

FIG. 23 is a front elevational view of a bone screw.

### DETAILED DESCRIPTION OF THE DISCLOSURE

The following describes a zygomatic dental implant, a guide for the zygomatic dental implant, a surgical method of implanting the zygomatic dental implant using the guide, and additional surgical instruments for the surgical method. It is understood that the above features described herein are not necessarily mutually inclusive, and one or more of the features may be utilized independently without necessarily utilizing one or more of the other features.

### First Embodiment

Zygomatic Dental Implant

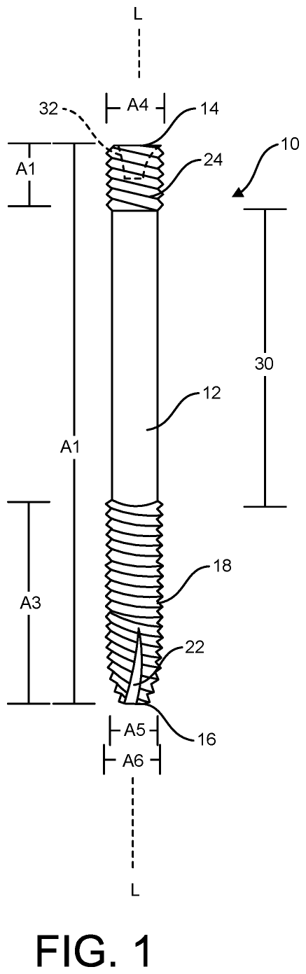

Referring to FIG. 1, an illustrated embodiment of a zygomatic dental implant is generally indicated at reference numeral 10. The zygomatic dental implant is suitable for being implanted using a zygomatic dental implant guide and surgical method described below herein. The illustrated zygomatic dental implant 10 includes an elongate shaft 12 (e.g., round shaft) having opposite proximal and distal ends 14, 16, respectively, and a length A1 extending therebetween. External threads 18 are disposed on an exterior of a distal longitudinal portion A3 of the shaft 12. The distal longitudinal portion A3 may also be referred to as the surgical end or surgical end portion of the implant 10. The external threads 18 may be acid etched and/or hydrophilic. A distal-most segment of the distal longitudinal portion A3 is tapered (e.g., conical) toward the distal end 16. The distal-most segment has a flute 22 configured to facilitate insertion of the implant 10 into the osseous tissue of the zygomatic arch. External threads 24 are disposed on the exterior of a proximal longitudinal portion A2 of the shaft 12. The proximal longitudinal portion A2 may also be referred to as the restorative end or restorative end portion of the implant 10. The external threads 24 may be acid etched and/or hydrophilic. The threaded proximal and distal longitudinal portions A2, A3, respectively, are spaced apart from one another along the length A1 of the shaft 12 such that an intermediate longitudinal portion 30 of the shaft 12 is unthreaded (e.g., smooth). A coupling opening 32 extends longitudinally through the proximal end 14 of the shaft 12. The opening 32 may be tapered toward the distal end 16 to facilitate coupling of a restorative component suitable for affixing a prosthetic thereto. The implant 10 may be integrally formed as a single, one-piece component. The implant 10 may comprise or be formed from suitable material for implantation into the zygomatic arch.

In a suitable embodiment of the zygomatic dental implant 10, the length A1 may be from about 35 mm to about 50 mm. A plurality of zygomatic dental implants 10 may be offered in lengths from about 35 mm to about 50 mm, in increments of about 2.5 mm. The diameter A5 of the shaft 12 may be from about 2 mm to about 5 mm, and in one or more embodiments, about 2 mm, or about 2.5 mm, or about 3 mm, or about 3.5 mm, or about 4 mm, or about 4.5 mm, or about 5 mm. The length of the threaded distal longitudinal portion A3 may be from about 10 mm to about 20 mm, and in one or more embodiments, about 14 mm, or about 15 mm, or about 16 mm, or about 17 mm, or about 18 mm. The length of the proximal longitudinal portion A2 may be from about 3 mm to about 7 mm, and in one or more embodiments, about 3 mm, or about 4 mm, or about 5 mm, or about 6 mm, or about 7 mm. The maximum diameters A6 of the threads 18, 24 may be from about 2.5 mm to about 5 mm, and in one or more embodiments, from about 2.5 mm, or about 3 mm, or about 3.5 mm, or about 4 mm, or about 4.5 mm, or about 5 mm. The diameter of the coupling opening 32 may be from about 1.5 mm to about 3.5 mm, and in one or more embodiments, about 1.5 mm, or about 2 mm, or about 2.5 mm, or about 3 mm, or about 3.5 mm. It is understood that the implant 10 may have other dimensions.

Zygomatic Dental Implant Guide

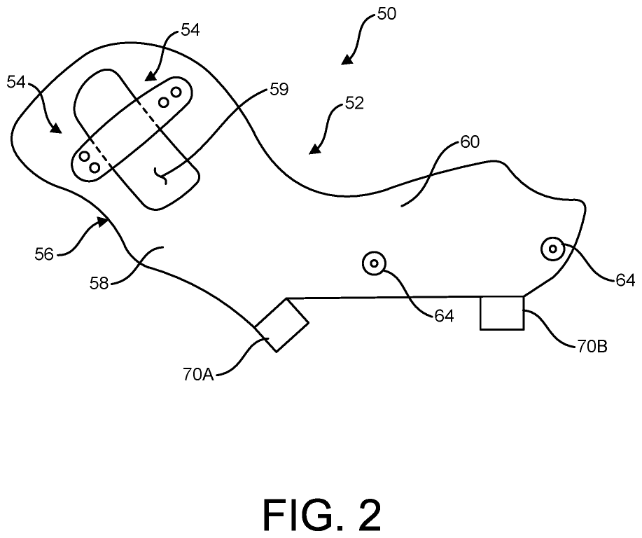

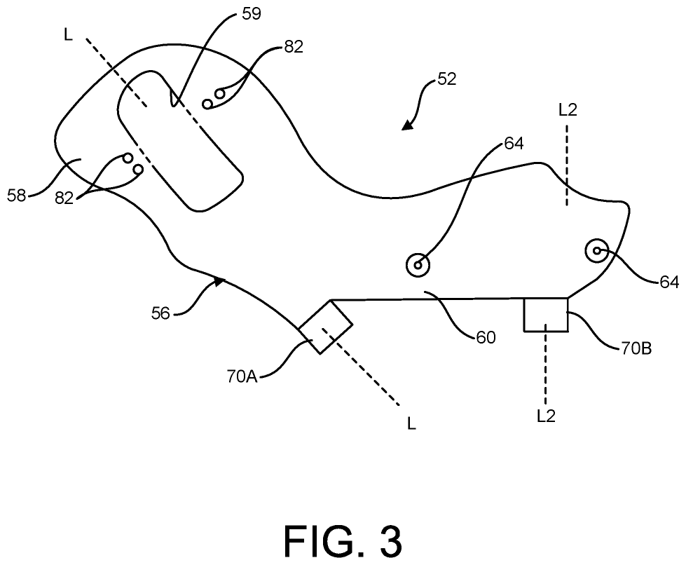

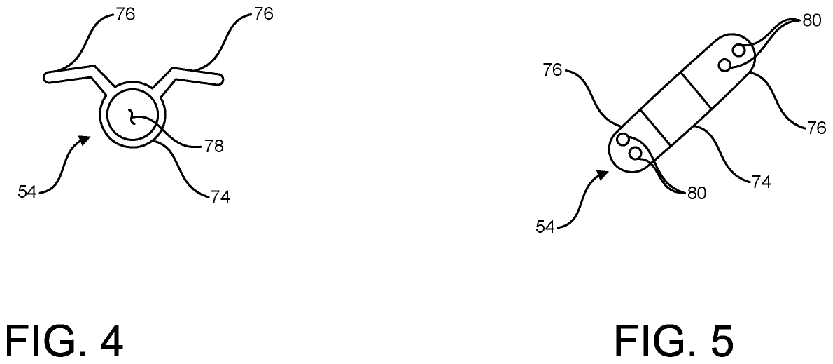

Referring to FIG. 2, an illustrated embodiment of a zygomatic dental implant guide is generally indicated at reference numeral 50. Referring also to FIGS. 3-5, the guide 50 generally includes a primary guide component (or stent) 52 and a secondary guide component (or stent) 54 that is removably attachable to the primary guide component. It is understood that the primary and secondary guide components 52, 54 may be non-removably connected or secured together, such as but not limited to, integrally formed as a one-piece component.

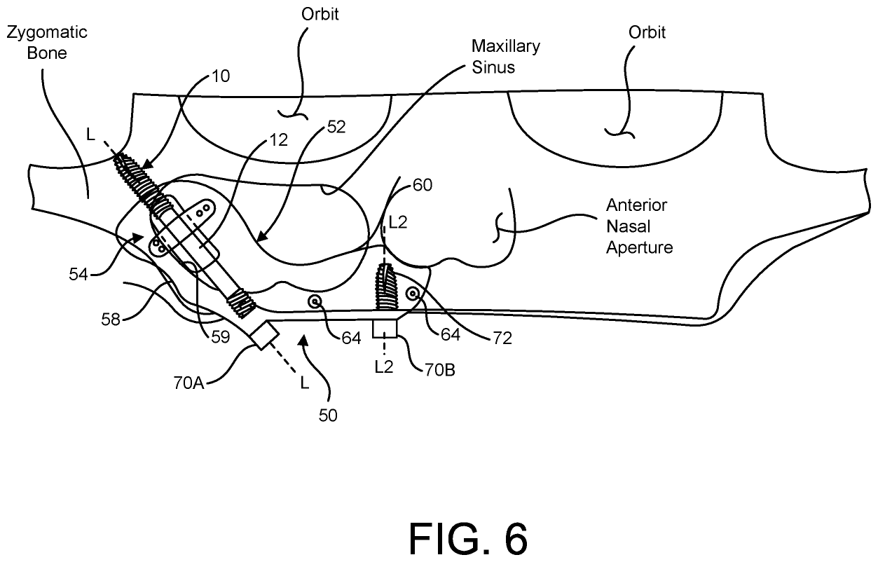

The primary guide component 52 includes a primary guide body 56. The guide body 56 may be generally thin and may be generally planar or bent into a generally curved shape. As shown in FIGS. 3 and 6, the primary guide body 56 includes a posterior portion 58 configured to generally conform to the bony contours of the zygomaticomaxillary buttress and the anterior maxillary wall. The posterior portion 58 also extends over and residual maxillary ridge and rests on the soft tissue of the posterior maxillary ridge. The posterior portion 58 defines a lateral window opening 59. The lateral window opening 59 generally coincides with the trajectory of the anticipated zygomatic implant 10 (i.e., the longitudinal axis implant axis L) traversing through the maxillary sinus. The lateral window opening 59 allows for accurate surgical preparation of the lateral sinus window to allow the secondary guide component 54 to be received in the lateral window opening 59 and seated on the primary guide component 52, as explained in more detail below. The illustrated lateral window opening 59 is elongate and is configured to extend along the longitudinal implant axis L generally in the superior/inferior direction when the primary guide component 52 is installed. In the illustrated embodiment, an anterior extension 60 of the body 56 extends anteriorly from the posterior portion 58. As shown in FIG. 6, the anterior extension 60 is configured to engage a portion of the ipsilateral piriform rim.

In one or more embodiments, the anatomic fit of the guide body 56, including the location of the lateral window opening 59, may be based on data acquired from one or both of a cone beam CT (CBCT) scan and a digital or analog impression of the patient's maxillary arch, for example. In this way, the dimensions of the guide body 56 may be customized to each individual patient. Other ways of making the customized guide body 56 are within the scope of the present disclosure. The illustrated guide body 56 also defines one or more fastener openings 64, such as openings in the anterior extension 60, configured to receive one or more fasteners (e.g., pins) to anchor or secure the primary guide component 52 to the patient.

The primary guide component 52 also includes at least one guide sleeve (e.g., two primary guide sleeves 70A, 70B) coupled to the guide body 56. A posterior primary guide sleeve 70A is coupled (e.g., fixedly or removably coupled) to an inferior surface of the posterior portion 58 of the guide body 56. The posterior primary guide sleeve 70A defines an opening having an axis that is coaxial with the longitudinal implant axis L. The posterior primary guide sleeve 70A may generally coincide with the proximal end 14 of the implant 10. An anterior primary guide sleeve 70B is coupled (e.g., fixedly or removably coupled) to an inferior surface of the anterior extension 60 of the guide body 56. The anterior primary guide sleeve 70B defines an opening having an axis L2 that is coaxial with an anterior implant 72 trajectory. As explained in more detail below, the guide sleeves 70A, 70B are used to accept various drill guide components including drill sleeves and guided implant mounts. In one example, the guide sleeves 70A, 70B may have an inner diameter of about 5 mm, and a length of about 5 mm.

The secondary guide component 54 includes a secondary guide sleeve 74 and a coupler 76 configured to removably couple the secondary guide component 54 to the primary guide component 52. The secondary guide sleeve 74 defines an opening 78 having an axis that is coaxial with the longitudinal implant axis L. When coupled to the primary guide component 52, the longitudinal center of the secondary guide sleeve 74 may be between about 20 mm and about 30 mm, and in one embodiment about 24 mm, from the distal end of the implant 10 along the longitudinal implant axis L. This allows for direct visualization of the implant 10 entering the zygoma at time of placement of the implant. Moreover, the secondary guide sleeve 74 being adjacent to the distal end of the implant 10 will minimize the amount of runout often seen with conventional techniques. In one example, the guide sleeve 74 may have an inner diameter of about 5 mm, and a length of about 5 mm. In the illustrated embodiment, the coupler 76 of the secondary guide component 54 includes a pair of wings extending laterally outward from the guide sleeve 74. The wings may define openings 80 configured to receive pins 82 extending outward from the face of the primary guide component 52, or pins may extend outward from the wings and be configured to be received in openings adjacent the window 59. Other ways of removably coupling the secondary guide component 54 to the primary guide component 52 are within the scope of the present disclosure.

Additional Instruments for Surgical Method

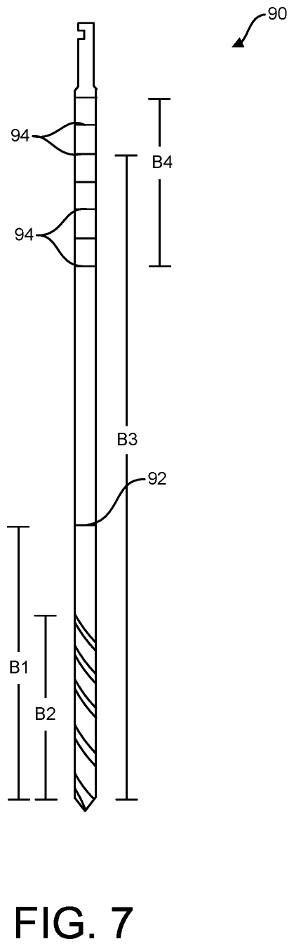

Additional surgical instruments for the surgical method described below are illustrated in FIGS. 7-12. These surgical instruments may be provided in one or more surgical instrument sets that are provided to the surgeon/hospital. The surgical instruments may not be customized, but instead, may be the same for all guided zygomatic implant surgeries, with variations in dimensions. In other embodiments, one or more of the instruments may be customized.

Referring to FIG. 7, a surgical drill bit 90 is generally indicated at reference numeral 90. The surgical drill bit 90 may be available in 2.2 mm, 2.8 mm, and 3.5 mm diameters. Lengths of the drill bit 90 is set to accommodate for variations in the secondary guide component 54 placement above the maxillary mucosa. The drill bit 90 may include a depth marking or indicia 92, such as a single, noncolor-coded band located at a fixed location, such as about 25 mm from a distal end of the drill bit. This location is formulated by the following: the location of the secondary guide sleeve 74 (e.g., 24 mm) along the longitudinal implant axis L plus a drill guide exposed length (e.g., 1 mm). Additional depth markings 94 are present at the proximal end portion of the drill bit 90 are coincident with the proximal end of the implant 10. These marking 94 are color coded to coincide with the colors designated for the length of each zygomatic implant 10 available. The markings 94 may be spaced in 2.5 mm increments. Drill bits may be available in 10 mm or 14 mm lengths in addition to the specified implant lengths.

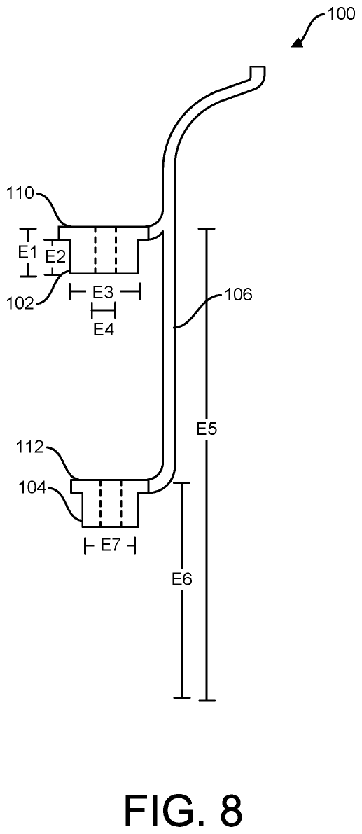

Referring to FIG. 8, a drill guide instrument is generally indicated at reference numeral 100. The illustrated drill guide instrument 100 is hand held, and formed as single piece component including spaced apart primary and secondary drill guides 102, 104 coupled to a stem 106. The drill guides 102, 104 have internal diameters. The drill guide instrument 100 may be available in different configurations, including drill guides having internal diameters corresponding to the available drill diameters of 2.2 mm, 2.8 mm, and 3.5 mm. The primary and secondary drill guides 102, 104 are simultaneously receivable in the respective primary and secondary guide sleeves 70A, 74. For example, outer diameters of the guides 102, 104 may intimately engage the respective internal diameters of the guide sleeves 70A, 74 the simultaneously. The outer diameters of the guides 102, 104 that engages the guide sleeves 70A, 74 may have lengths of about 4 mm. The guides 102, 104 may also include collars 110, 112 that rest on the respective guide sleeves 70A, 74 and function as stops. The collars 110 may have lengths of about 1 mm.

An implant coupling is configured to engage and couple with internal attachment of the implant 10 at its proximal end. Markings of the implant coupling may be provided present to assist the surgeon in accurate implant timing (rotational positioning) at placement. The implant coupling may include a vertical stop to facilitate accurate depth of implant insertion.

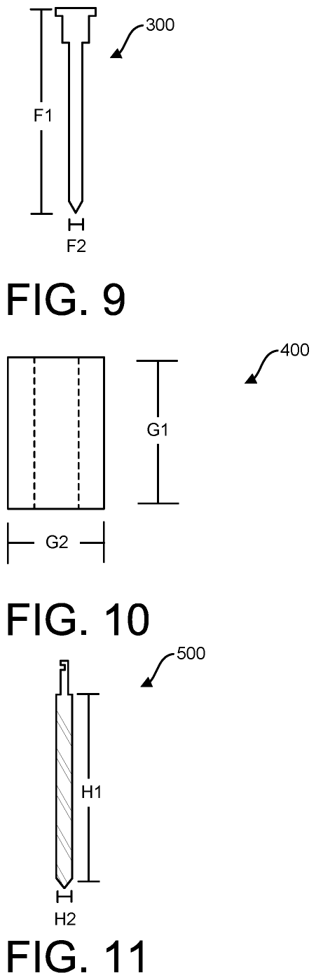

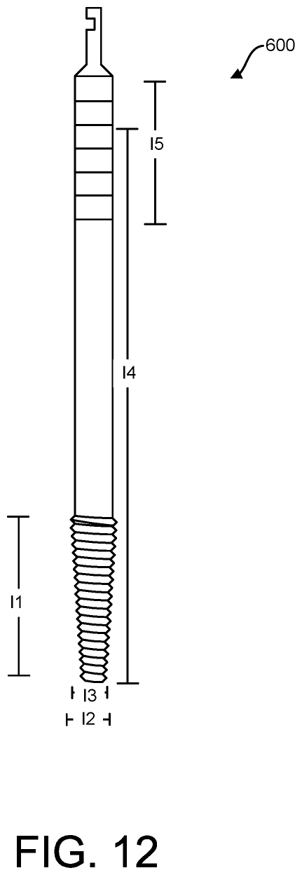

Additional suitable instruments are illustrated in FIGS. 9-12. FIG. 9 illustrates a suitable stabilization pin at reference numeral 300; FIG. 10 illustrates a suitable stabilization pin sleeve at reference numeral 400; FIG. 11 is a stabilization pin drill bit 500; and FIG. 12 illustrates a tap drill at reference numeral 600.

Suitable, exemplary dimensions for the zygomatic implant 10, the implant guide 50, and the surgical instruments illustrated in FIGS. 9-12, are provided in Table 1, below.

| | | |
|---|---|---|
| A1 | Zygoma Implant: Overall | 35-50 mm |
| | length | Available in 2.5 mm |
| | | increments |
| A2 | Zygoma Implant: Length of | 5.0 mm |
| | restorative end threads | |
| A3 | Zygoma Implant: Length of | 16 mm |
| | surgical end threads | |
| A4 | Zygoma Implant: Diameter of | 2.7 mm |
| | restorative opening to internal | |
| | connection | |
| A5 | Zygoma Implant: Diameter of | 3.5 mm |
| | implant body | |
| A6 | Zygoma Implant: Diameter of | 4.1 mm |
| | implant at threaded portions | |
| B1 | Surgical Drill Bit: set depth | 24 mm |
| | marking | |
| B2 | Surgical Drill Bit: cutting end | 16 mm |
| | length | |
| B3 | Surgical Drill Bit: Length | 65 mm + Latch attachment |
| B4 | Surgical Drill Bit: Implant | Depicting 35-50 mm |
| | length markings. Maybe | implant lengths each 2.5 mm |
| | color coded | increment. Set at implant |
| | | length + 12 mm |
| C1 | Primary Guide Sleeves: Inner | 5.0 mm |
| | diameter | |
| C2 | Primary Guide Sleeves: Height | 5.0 mm |
| D1 | Secondary Guide Sleeve: Inner | 5.0 mm |
| | diameter | |
| D2 | Secondary Guide Sleeve: | 5.0 mm |
| | Height | |
| E1 | Drill Guide: Total Insert | 6.0 mm |
| | Length | |
| E2 | Drill Guide: Engaging Length | 5.0 mm |
| E3 | Drill Guide: Outer Diameter | 6.0-7.0 mm |
| E4 | Drill Guide: Inner Diameter | 2.2, 2.8, and 3.5 mm |
| | | available |
| E5 | Drill Guide for Primary Guide | Set at implant length + |
| | Sleeve | 12 mm |
| | | Available for each implant |
| | | length offered. |
| E6 | Drill Guide for Secondary | 24 mm |
| | Guide Sleeves | |
| E7 | Drill Guide for Secondary: | 5.0 mm |
| | Outer Diameter | |
| F1 | Stabilization Pin: Length | 24 mm |
| F2 | Stabilization Pin: Diameter | 1.6 mm |
| G1 | Stabilization Pin Sleeve: | 5.0 mm |
| | Length | |
| G2 | Stabilization Pin Sleeve: Outer | 3.5 and 1.6 mm |
| | and Internal Diameters | |
| H1 | Stabilization Pin Drill Bit: | 25 mm + Latch attachment |
| | Length | |
| H2 | Stabilization Pin Drill Bit: | 1.6 mm |
| | Diameter | |
| I1 | Tap Drill: Length of tapping | 16 mm |
| | threads | |
| I2 | Tap Drill: Diameter of tap at | 4.1 mm |
| | threaded portion | |
| I3 | Tap Drill: Diameter of tap | 3.5 mm |
| | body | |
| I4 | Tap Drill: Length | 65 mm + Latch attachment |
| I5 | Tap Drill: Depth markings. | Depicting 35-50 mm |
| | May be color coded | implant lengths each 2.5 mm |
| | | increment. Set at implant |
| | | length + 12 mm |

Surgical Method

One example of a surgical method for implanting the zygomatic implant 10 using the implant guide 50 is described below.

Step 0: Implant positioning is based off of virtual surgical planning software. A virtual point is placed at anatomic J point. J point is defined as the intersection of the anterior extension of the zygomatic arch and the inferior most extension of the frontal process of the maxillary bone. A second virtual point (R point) is placed at the ideal restorative position of the implant 10 at or near the crest of the posterior maxillary ridge. The software will autofill a zygomatic implant 10 of ideal length along this axis. Its position can then be modified if need be via repositioning J point, R point, or both until an ideal implant position is achieved.

Step 1: An incision is made near the crest of the edentulous maxillary ridge with necessary anterior and posterior extensions to allow for adequate seating of the guide 10. Mucosa is elevated in a subperiosteal plane to expose the zygomaticomaxillary buttress and anterior maxillary wall. Further dissection is performed to the ipsilateral piriform rim if anterior implants 72 are designed into the guide plan. There is no need to expose J point completely. Minimal dissection along the inferior lateral aspect of the nasal floor may be required for complete guide seating.

Step 2: The primary guide component 52 is positioned on the lateral maxilla until it is fully seated into its planned position. The primary guide component 52 may be stabilized with the guide pins 300. Guide pin osteotomies are prepared through the guide pin sleeves 400 with the guide pin drill bit 500 provided at the specified rpm. The guide pin(s) 300 are inserted such as by using digital pressure while ensuring the primary guide component 52 does not displace from its ideal position.

Step 3: Using a surgical bur and copious irrigation, the lateral maxillary sinus window is created along the outline of the sinus window opening 59 defined by the primary guide component 52. The lateral window is created to be flush with the primary guide component 52. The bone can be harvested for grafting if need be.

Step 4: The secondary guide component 54 is coupled to the primary guide component 52 so that the secondary guide sleeve is inserted into lateral window through the lateral window opening 59. The secondary guide component 54 is fully seated and coupled to the primary guide component 52.

Step 5: The initial 2.2 mm drill guide instrument 100 is utilized such that the drill guides 102, 104 are received in the respective guide sleeves 70A, 74. The initial osteotomy is created using the 2.2 mm drill bit 90 using copious irrigation at the recommended rpm. Proper depth is achieved when the desired depth 94 on the drill bit is flush with the drill guide 102. The 2.2 mm drill guide instrument 100 is then removed.

Step 6: The 2.8 mm drill guide instrument 100 is utilized such that the drill guides 102, 104 are received in the respective guide sleeves 70A, 74. The 2.8 mm drill bit 90 is used to proper depth using the same protocol as the previous drill bit. The 2.8 mm drill guide instrument 100 is then removed.

Step 7: The 3.5 mm drill guide instrument 100 is utilized such that the drill guides 102, 104 are received in the respective guide sleeves 70A, 74. The 3.5 mm drill bit 90 is used to proper depth using the same protocol as the previous drill bit. The 3.5 mm drill guide instrument 100 is then removed. This completes the site preparation unless bone density dictates that a bone tap 500 be used prior to the implant 10 insertion.

Step 8 (Optional): If the density of the site dictates that a bone tap 500 is necessary to prevent high implant insertion torque, the guided bone tap is used under copious irrigation at 35 rpm. Continue until the guided stop of the bone tap 500 is flush with the guide sleeve 70A.

Step 9: If anterior implants 72 are planned for the case, the anterior implant sites are prepared per manufacturers specifications.

Step 10: The secondary guide component 54 is removed from the primary guide component 52, without displacing the primary guide component.

Step 11: The implant 10 is implanted. The guided implant mount provided in an implant handpiece is used to implant the implant. The zygomatic implant 10 is implanted into proper depth. Depth is achieved when the guided implant mount is flush with the primary guide sleeve 70A. Proper timing (rotational positioning) of the guided implant mount is ensured by conforming markings align with the markings on the primary guide component 52. If complete seating of the implant 10 cannot be achieved using the surgical handpiece, complete its seating with the torque wrench provided.

Step 12: The anterior implants are implanted using guided technique specified by manufacturer.

Step 13: The guide pins 300 and the primary guide component 52 are removed from the patient. Final positioning of the implants 10, 72 are confirmed.

Step 14: Desired prosthetic components are coupled to the implants 10, 72 (i.e. angled restorative abutments, healing caps).

Step 15: Mucosal is sutured around restorative components to achieve primary wound closure.

### Second Embodiment

Another embodiment of a zygomatic dental implant, a guide for the zygomatic dental implant, a surgical method of implant the zygomatic dental implant using the guide, and additional surgical instruments for the surgical method is described below.

Zygomatic Dental Implant

The zygomatic dental implant(s) may be the same as described above with respect to the first embodiment and as shown in FIG. 1 at reference numeral 10. Accordingly, the teachings set forth above with respect to the zygomatic implant of the first embodiment applies equally to the second embodiment.

Zygomatic Dental Implant Guide

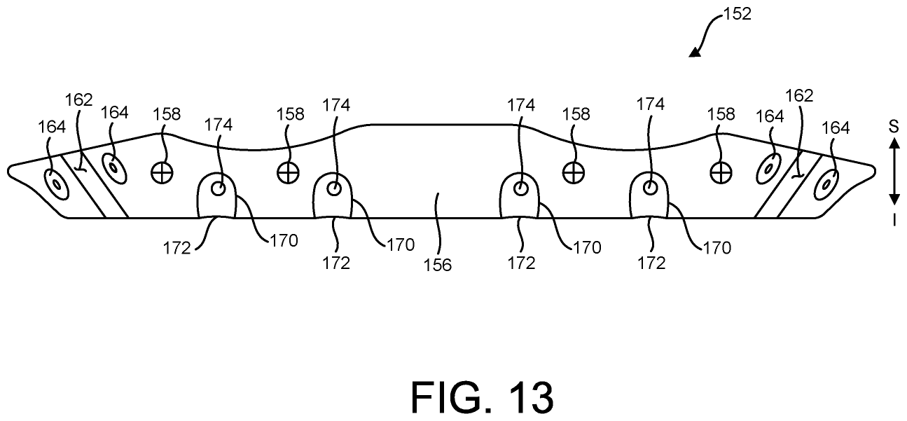

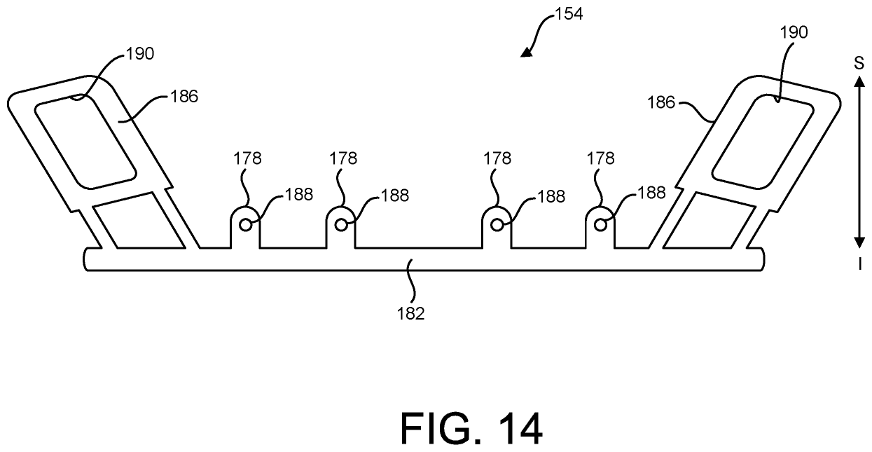

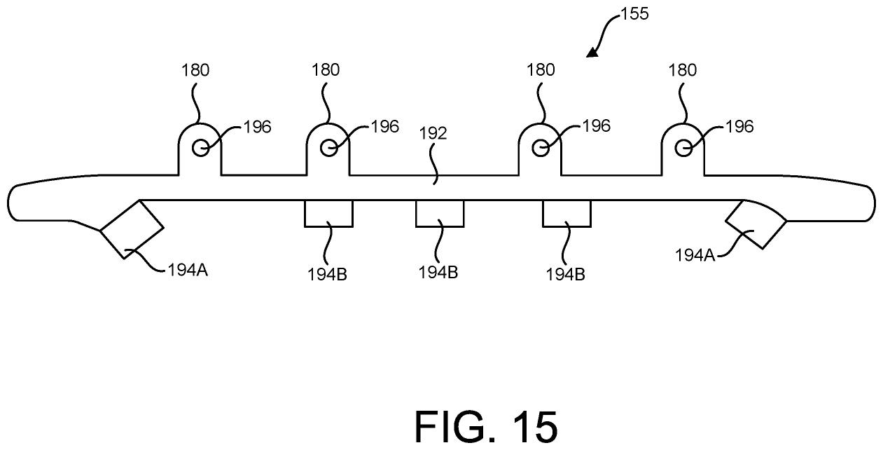

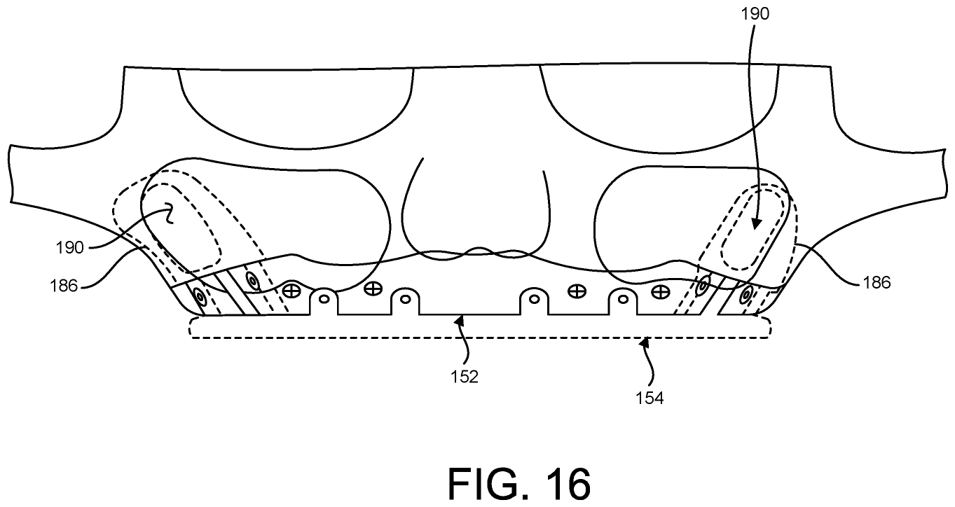

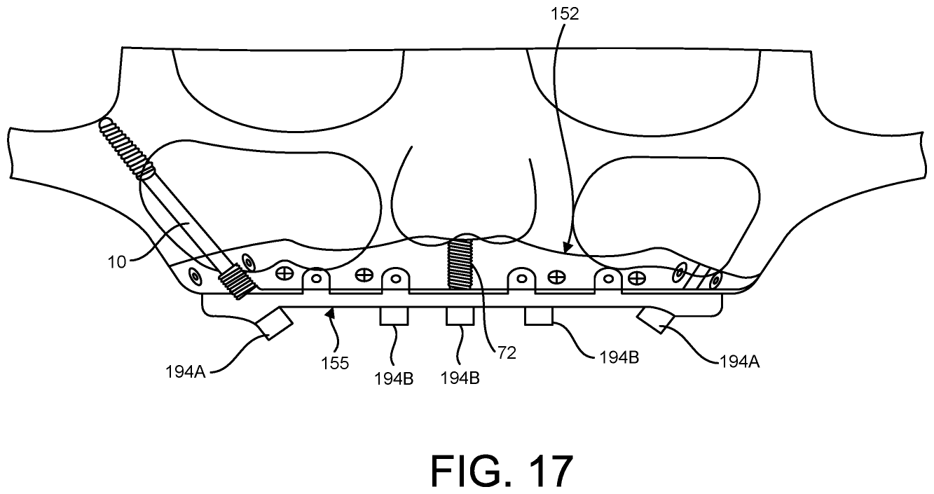

Referring to FIGS. 13-17, an exemplary zygomatic implant guide includes a primary guide component 152 and two secondary guide components 154, 155 (FIGS. 14 and 15) removably attachable to the primary guide component, such as shown in FIGS. 16 and 17. As explained below, the secondary guide components include a sinus-preparation component 154 and an implant guide component 155.

Referring to FIG. 13, the primary guide component 152 includes a primary guide body 156. The guide body 156 may be generally thin and may be generally planar or bent into a generally curved shape in the anterior-posterior direction. As shown in FIGS. 16 and 17, the primary guide body 156 extends across an anterior surface of the palantine process of the maxilla and may engage the piriform rim and zygomatic buttress bilaterally. The primary guide component can be anatomically adapted to the maxilla based off of CBCT data. The primary guide body 156 defines a plurality of fastener openings 158 configured to receive fasteners (e.g., bone screws 160, see FIG. 21, for example) to attach the primary guide component 152 to the maxilla. The primary guide body 156 further defines stabilization channels 162 at the opposite posterior ends thereof. The channels 162 are configured to provide stabilization for insertion of the drill guide instrument 100 and its stem 106. In one example, posts 164 extend anteriorly from the primary guide body 156 on either side of the stabilization channel 162. Each pair of posts 164 may be configured to receive a stabilizing pin 166 therebetween that opposes and is spaced anterior of the corresponding stabilization channel 162. The posts and the pin 164, 166 are designed to prevent any rotation or torqueing movement of the drill guide instrument during site preparation.

Referring still to FIG. 13, the primary guide body 156 also includes secondary-component couplings 170 configured to couple to the sinus-preparation component 154 and the implant guide component 155. In the illustrated embodiment, the secondary-component couplings 170 include openings (e.g., slots) 172 extending through an inferior side of the primary guide body 156 in a superior direction. Openings 174 extending through an anterior face of the primary guide body 156 and are in registration with the corresponding slots 172. As explained below, in general the secondary-component couplings 170 are female couplings configured to receive male couplings 178, 180 (FIG. 14-17) of the secondary guide components 154, 155, and the openings 174 are configured to receive pins or other fasteners (e.g., set screws) to fasten the male couplings in the slots 172 of the female couplings.

Referring to FIG. 14, the sinus-preparation component 154 includes a sinus-preparation body 182, the male couplings 178 extending superiorly from the sinus-preparation body, and a sinus-preparation guide 186 extending generally superiorly adjacent each posterior end of the sinus-preparation body. The male couplings 178 are configured to be inserted into the corresponding female couplings 170 (or slots 172 thereof) of the primary guide component 152, as shown in FIG. 16. The illustrated male couplings 178 include tabs or projections extending from the sinus-preparation body 182. Each coupling tab 178 defines an opening 188 that is alignable with the opening 174 associated with the corresponding female coupling 170 when the coupling tab is inserted into the female coupling. Once coupled and with the openings 174, 178 aligned, a pin or other fastener can be inserted through the openings to fasten the sinus-preparation component 154 to the primary guide component 152. The sinus-preparation component 154 may be removably couplable to the primary guide component 152 in other ways in other embodiments.

As shown in FIG. 16, when coupled to the primary guide component 152 and when the primary guide component is fastened to the maxillary, the sinus-preparation guide 186 extends over maxillary ridge and rests on the soft tissue of the posterior maxillary ridge. The sinus-preparation guide 186 defines a lateral window opening 190. The lateral window opening 190 generally coincides with the trajectory of the anticipated zygomatic implant 10 (i.e., the longitudinal axis implant axis L) traversing through the maxillary sinus. The lateral window opening 190 allows for accurate surgical preparation of the lateral sinus window. The illustrated lateral window opening 190 is elongate and is configured to extend along the longitudinal implant axis L generally in the superior/inferior direction when the sinus-preparation guide is installed on the primary guide component. As can be understood, in the first embodiment the sinus preparation guide 59 can be said to be integrally formed with the primary guide component, while in the second embodiment, the sinus-preparation guide 186 is separate from and removably attachable to the primary guide component 152.

In one or more embodiments, the anatomic fit of the primary guide component 152 and the sinus-preparation guide 154, including the location of the lateral window opening 190, may be based on data acquired from one or both of a cone beam CT (CBCT) scan and a digital or analog impression of the patient's maxillary arch, for example. In this way, the dimensions of the primary guide component 152 and/or the guide sinus-preparation guide 154 may be customized to each individual patient. Other ways of making the customized primary guide component 152 and sinus-preparation guide 154 are within the scope of the present disclosure.

Referring to FIGS. 15 and 17, the implant guide component 155 includes an implant-guide body 192, the male couplings 180 extending superiorly from the implant-guide body, and at least one implant guide sleeve 194A, 194B extending generally inferiorly from the guide body. As with the prior male couplings 178, the present male couplings 180 are insertable into corresponding female couplings 170 (e.g., slots 172 thereof) of the primary guide component 152. The illustrated male couplings 180 include tabs or projections extending from the sinus-preparation body 192. Each coupling tab 180 defines an opening 196 that is alignable with the opening 174 associated with the corresponding female coupling 170 when the coupling tab is inserted into the female coupling. Once coupled and the openings 174, 196 are aligned, a pin or other fastener can be inserted through the openings to fasten the implant guide component 155 to the primary guide component 152. The implant-guide component 154 may be removably couplable to the primary guide component 152 in other ways in other embodiments.

The at least one implantation guide sleeve includes a plurality of guide sleeves (e.g., five primary guide sleeves 194A, 194B) coupled to the implant-guide body 192. Posterior primary guide sleeves 194A are coupled (e.g., fixedly or removably coupled) to an inferior surface of the implant-guide body 192 generally adjacent the opposite posterior ends thereof. The primary guide sleeves 194A define openings each having an axis that is coaxial with the longitudinal implant axis L and the clearance channel 162. Each primary implant guide sleeve 194A may generally coincide with the proximal end 14 of the implant 10. The other implant guide sleeves may be anterior auxiliary implant guide sleeves 194B coupled (e.g., fixedly or removably coupled) to the inferior side of the implant-guide body 192 adjacent an anterior portion of thereof. Each auxiliary implant guide sleeve 194B defines an opening having an axis that is coaxial with an anterior implant 72 trajectory. As explained in more detail below, the guide sleeves 194A, 194B are used to accept various drill guides.

Additional Instruments for Surgical Method

Each of the instruments shown in FIGS. 7, 8 and 10-12 and described above may be used with the present embodiments in a manner similar to that described above with respect to the first embodiment. Moreover, instead of the stabilization pin shown in FIG. 9, the bone screw 160 shown in FIG. 23 may be used.

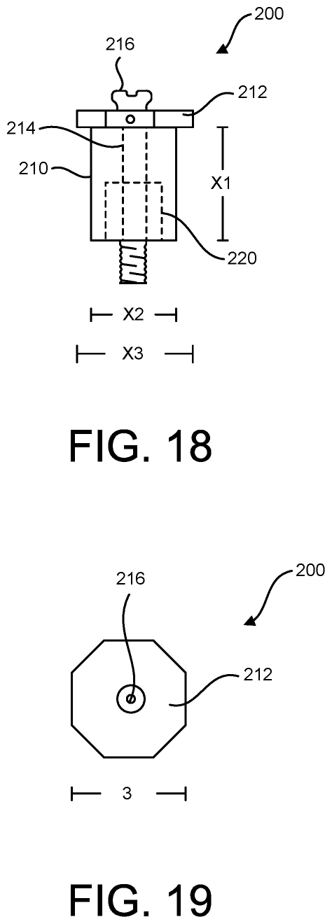

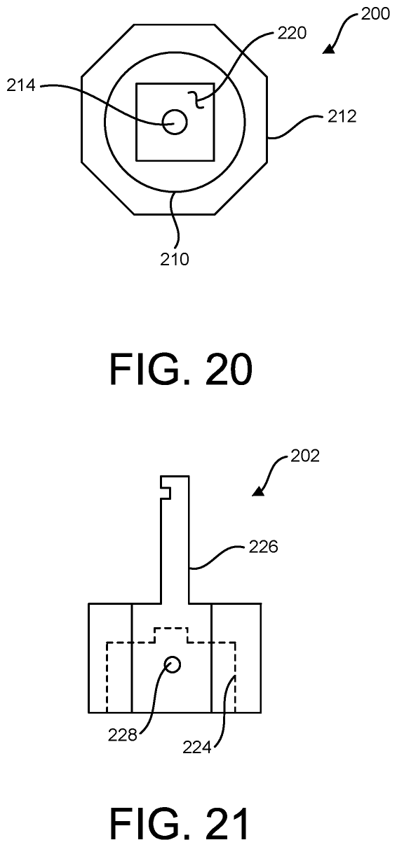

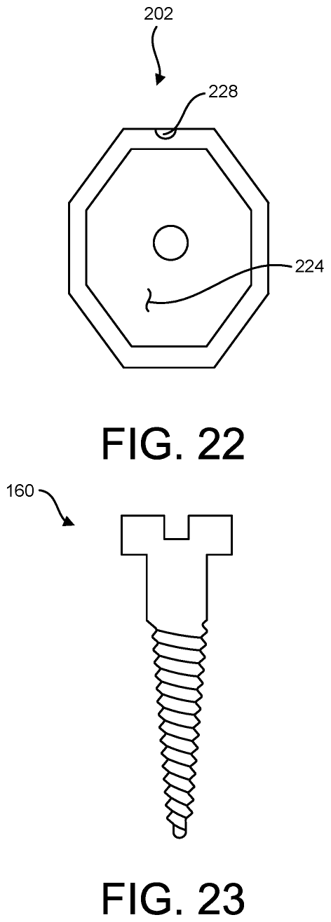

In addition to the instruments describe above, the present embodiment may include a zygomatic implant mount 200, shown in FIGS. 18-20, and an implant driver 202, shown in FIGS. 21 and 22. The zygomatic implant mount 200 is configured to mount to one of more types of zygomatic implants 10, 72, and the implant driver 202 is configured to engage the implant mount to facilitate implantation of the implant.

Referring to FIGS. 18-20, the illustrated implant mount 200 includes a generally cylindrical mount body 210 sized and shaped to be received in the implant guide sleeves 194A, 194B; a body head 212 (e.g., hexagonal head) on the body configured to be engaged by the implant driver 202; and a threaded mount fastener 214 rotatably coupled to the body and configured to threadably fasten to the restorative head of the implant 10, 72 or a manufacturer's existing implant mount. A diameter X3 of the mount body 210 is slightly smaller than an inner diameter of the guide sleeves 194A, 194B so that the mount body fits snugly therein. A length X1 of the mount body 210 is such that the head 212 engages the guide sleeve 194A, 194B when the implant 10, 72 is fully threaded in the zygomatic bone at the desired depth, and corresponding to the desired location of the restorative head of the implant. The threaded mount fastener 214 extends through the body head 212 and an opposite first end of the mount body so that threads of the mount fastener are exposed, as shown in FIG. 18. A head 216 of the mount fastener 214 is adjacent the body head 212 and is accessible with a tool (e.g., driver) to thread the mount fastener into the restorative head of the implant 10, 72. The cylindrical body 210 defines a recess 220 extending from the first end thereof to receive the restorative head of the zygoma implant or the manufacturer's existing implant mount when it is threadably coupled to the mount fastener 214. The perimeter shape (e.g., square, hexagonal, octagonal, or another polygonal shape) of the recess 220 may generally correspond to the perimeter shape of the restorative head of the implant 10, 72 or the manufacturer's existing implant mount.

Referring to FIGS. 21 and 22, the implant driver 202 includes a bit defining a recess 224 sized and shaped (e.g., hexagonal, octagonal, square, or other polygonal shape) to receive at least the body head 212 of the implant mount 200. A stem 226 including a latch or other attachment facilitates coupling to an implant drill and/or a torque wrench. A central indicating mark 228 or indicia is coincident with the location of the restorative platform of the zygomatic implant 10, 72.

Surgical Method

One example of a surgical method for implanting the zygomatic implant 10 using the second embodiment of the implant guide is described below.

Steps 0 and 1 are performed as described above with respect to the first embodiment.

Step 2A: The primary guide component 152 is positioned on the maxilla until it is fully seated into its planned position. The primary guide component 152 may be stabilized with the bone screws 160. Bone screw osteotomies are prepared through the guide sleeves 400 with the guide pin drill bit 500 provided at the specified rpm. The bone screws 160 are inserted through the fastener openings 158 in the primary guide component 152 to secure the primary guide component to the maxillary.

Step 2B: The sinus-preparation component 154 is then coupled to the primary guide component by inserting the male couplings 178 into the female couplings 170, as shown in FIG. 16. The pins may be inserted through the aligned openings 174, 188 to secure the sinus-preparation component 154 to the primary guide component 152.

Step 3: Using a surgical burr and copious irrigation, the lateral maxillary sinus window is created along the outline of the sinus window opening 190 defined by the sinus-preparation component 154. The lateral window is created to be flush with the window opening 190. The bone can be harvested for grafting if need be. After creating the window, the sinus-preparation component 154 is decoupled from the primary guide component 152, while the primary guide component remains fastened to the maxillary.

Step 4: The implant guide component 155 is then coupled to the primary guide component 152 by inserting the male couplings 180 into the female couplings 170, as shown in FIG. 17. The pins may be inserted through the aligned openings 174, 196 to secure the implant guide component 155 to the primary guide component 152.

Step 5: The initial 2.2 mm drill guide instrument 100 is utilized such that the drill guide 102 is received in the respective guide sleeve 194A. The stem of the drill guide instrument 106 will intimately rest within the stabilization channel 162 to ensure proper angulation of drilling sequence. The initial osteotomy is created using the 2.2 mm drill bit 90 using copious irrigation at the recommended rpm. Proper depth is achieved when the desired depth 94 on the drill bit is flush with the drill guide 102. Depth 94 on the drill will also coincide with the top of drill guide 104. The 2.2 mm drill guide instrument 100 is then removed.

Step 6: The 2.8 mm drill guide instrument 100 is utilized such that the drill guide 102 is received in the respective guide sleeve 194A. The 2.8 mm drill bit 90 is used to proper depth using the same protocol as the previous drill bit. The 2.8 mm drill guide instrument 100 is then removed.

Step 7: The 3.5 mm drill guide instrument 100 is utilized such that the drill guide 102 is received in the respective guide sleeve 194A. The 3.5 mm drill bit 90 is used to proper depth using the same protocol as the previous drill bit. The 3.5 mm drill guide instrument 100 is then removed. This completes the site preparation unless bone density dictates that a bone tap 500 be used prior to the implant 10 insertion.

Step 8 (Optional): If the density of the site dictates that a bone tap 500 is necessary to prevent high implant insertion torque, the guided bone tap is used under copious irrigation at 35 rpm. Continue until the guided stop of the bone tap 500 is flush with the guide sleeve 194A.

Step 9: If anterior implants 72 are planned for the case, the anterior implant sites are prepared per manufacturers specifications.

Step 10: The implants 10 are implanted. The implant mount 200 and driver 202 provided used to implant the implant 10. The zygomatic implant 10 is implanted into proper depth. Depth is achieved when the guided implant mount 200 is flush with the primary guide sleeve 194A. Proper timing (rotational positioning) of the guided implant mount is ensured by conforming markings 228 align with the markings on the primary guide component 152 or the implant guide component 192. If complete seating of the implant 10 cannot be achieved using the surgical handpiece, complete its seating with the torque wrench provided.

Step 11: The anterior implants 72 are implanted using guided technique specified by manufacturer.

Step 12: The mount screws and the primary guide component 152 are removed from the patient. Final positioning of the implants 10, 72 are confirmed.

Step 13: Desired prosthetic components are coupled to the implants 10, 72 (i.e. angled restorative abutments, healing caps).

Step 14: Mucosal is sutured around restorative components to achieve primary wound closure.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A zygomatic dental implant guide comprising:
a guide body configured to be secured to a maxillary of a subject; and
a guide sleeve coupled to the guide body and configured to receive a zygomatic implant and guide the zygomatic implant toward a zygoma of the subject.

2. A method of implanting a zygomatic dental implant into a subject, the method comprising:
securing a guide body to a maxillary of a subject;
inserting zygomatic implant through a guide sleeve coupled to the guide body; and
securing the zygomatic implant to a zygoma of the subject.
